(19) United States
(12) Patent Application Publication
(10) Pub. No.: US 2024/0085160 A1
(43) Pub. Date: Mar. 14, 2024

(54) COLD SPRAY ADDITIVE MANUFACTURING OF FRAGMENTATION BOMBS AND WARHEADS

(71) Applicant: TRITON SYSTEMS, INC., Chelmsford, MA (US)

(72) Inventors: William STORY, Southbridge, MA (US); Arthur Gavrin, Manchester, NH (US)

(21) Appl. No.: 18/465,013

(22) Filed: Sep. 11, 2023

Related U.S. Application Data
(60) Provisional application No. 63/375,157, filed on Sep. 9, 2022.

(51) Int. Cl. F42B 33/14; C23C 24/04; F42B 3/28

(52) U.S. Cl. CPC F42B 33/14; C23C 24/04; F42B 3/28

(57) ABSTRACT

Disclosed herein are methods of making fragmentation casings for bombs and warheads. Particularly, cold spray methods are used. A layer or layers of metal, metal alloy, and optional other materials are deposited by cold spray application of cold spray materials to preform/mandrel, having patterned structures to define fragmentation points (e.g., stress concentrators) in a fragmentation casing formed on the preform/mandrel via cold spray. In addition to such cold spray processes for forming a fragmentation casing, this disclosure relates to the preform/mandrels used as well as the resultant fragmentation casing formed via cold spray.

### RELATED APPLICATIONS

This application claims priority to U.S. Provisional Application Ser. No. 63/375,157 filed on Sep. 9, 2022, the content of which is hereby incorporated by reference in its entirety.

### STATEMENT OF GOVERNMENT INTEREST

This invention was made with government support under contract/Job No. HQ0860-22-C-70XX awarded by U.S. MDA. The government has certain rights in the invention.

### BACKGROUND

Despite advancements in missile technology, fragmentation warhead casings are often still produced using legacy materials, most commonly steel. Application of new developments in manufacturing methods and advanced materials have the potential to significantly enhance the efficacy of fragmentation warheads on existing platforms. Advancements in additive manufacturing enable fabrication of geometries impracticable or impossible using traditional machining. New manufacturing methods allow for the use of novel materials with much higher density than steel and with secondary incendiary effects. Accordingly, there is a need to employ such methods and materials to manufacture fragmentation bombs and warheads, as disclosed herein.

### SUMMARY

Some embodiments provide a cold spray material comprising a metal, or alloy thereof, (optionally) a ceramic, another, dissimilar metal or metal alloy, or a metal or metal alloy coated with a second dissimilar metal or metal alloy, or a ceramic coated with a metal or metal alloy, ceramic composite, metal-metal composite, or a combination thereof.

In some embodiments, there are two or more of any of the ceramic, another, dissimilar metal or metal alloy, or metal or metal alloy coated with a second dissimilar metal or metal alloy, or a ceramic coated with a metal or metal alloy, or a combination thereof.

In some embodiments, the metal alloy comprises Tantalum or alloy thereof and the ceramic is a Tungsten Oxide Composite.

In some embodiments, the material is a metal-metal composite.

In some embodiments, the material is a metal-metal composite consisting of a metal combination which releases energy upon reaction.

In some embodiments, the material is produced by spraying a mixture of ductile metal powder with a brittle metal powder.

In some embodiments, the mixture is a mechanical mixture with substantially no chemical interaction before spraying.

In some embodiments, the mixture is a mixture of tantalum or an alloy thereof and tungsten or an alloy thereof.

In some embodiments, the cold spray material is produced by using brittle metals which are coated, encapsulated, or decorated with a thin ductile metal prior to spraying.

In some embodiments, the brittle metal is tungsten, and the thin ductile metal is copper.

Some embodiments provide a method for making a fragmentation casing, said process comprising the consolidation of a cold spray material on a preform/mandrel, wherein said preform/mandrel comprises one or more of a geometry, shape, texture, projection, aperture, depression, or other feature for imparting a plurality of fragmentation sites on the fragmentation casing.

In some embodiments, the cold spray material used in the method is a cold spray material as recited above.

Some embodiments provide a fragmentation casing comprising a spray-coated casing material comprising a metal, or alloy thereof and (optionally) a ceramic, another, dissimilar metal or metal alloy, or a metal or metal alloy coated with a second dissimilar metal or metal alloy, or a ceramic coated with a metal or metal alloy, or a combination thereof; further comprising an imprinted structure (e.g., stress concentrators) for directing fragmentation.

In some embodiments, the spray-coated casing material comprises two or more of any of the ceramic (i.e., metal oxide, metal non-oxide), another, dissimilar metal or metal alloy, or metal or metal alloy coated with a second dissimilar metal or metal alloy, or a ceramic coated with a metal or metal alloy, or a combination thereof.

In some embodiments, the fragmentation casing is for a bomb or a warhead.

Some embodiments provide a fragmentation casing for a bomb or warhead made by the spray coating process described herein.

Some embodiments provide a preform/mandrel for forming a fragmentation casing, the preform/mandrel comprising features one or more of a geometry, shape, texture, projection, aperture, depression, or other feature for imparting a plurality of fragmentation sites on the fragmentation casing formed on the preform/mandrel.

### BRIEF DESCRIPTION OF THE DRAWINGS

Aspects, features, benefits, and advantages of the embodiments described herein will be apparent with regard to the following description, appended claims, and accompanying drawings where:

FIG. 1 depicts a method to produce high density reactive material fragmentation warheads with a dual additive manufacturing approach in accordance with some embodiments herein.

### DETAILED DESCRIPTION

Disclosed herein are methods of making fragmentation casings for bombs and warheads. Particularly, cold spray methods are used. A layer or layers of metal, metal alloy, and optional other materials are deposited by cold spray application of cold spray materials to preform/mandrel, having patterned structures to define fragmentation points (e.g., stress concentrators) in a fragmentation casing formed on the preform/mandrel via cold spray.

In addition to such cold spray processes for forming a fragmentation casing, this disclosure relates to the preform/mandrels used as well as the resultant fragmentation casing formed via cold spray.

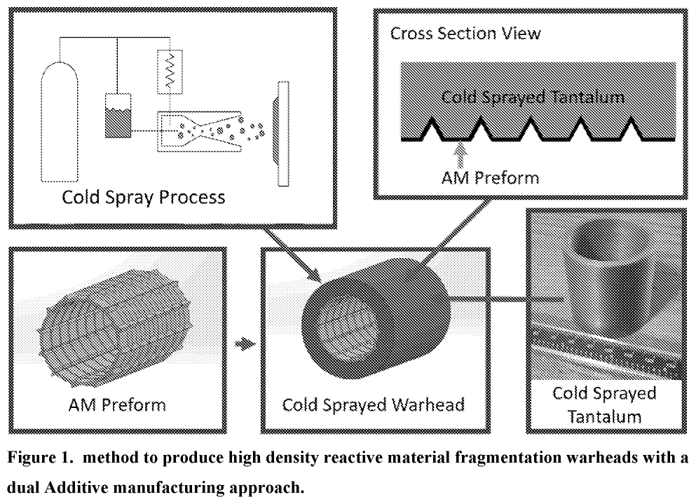

Described herein are Additive Manufacturing (AM) methods to produce high-density, reactive material fragmentation warheads, cold spray materials used in such methods, and fragmentation casings made therefrom. These warheads would have use in a variety of platforms including anti-ballistic missiles, anti-ship missiles, anti-vehicle missiles, and anti-personnel bombs. AM allows for fabrication of intricate geometries not achievable with conventional machining methods, allowing the internal geometry of the warhead to be designed for optimized fragmentation. A drawback of traditional AM can be the relatively low build rate and limitation to one material for the build. On the other hand, cold spray allows for high build rates (up to 10 kg/hr) and the use of multiple materials. While cold spray cannot produce geometries as intricate as traditional AM methods, it can be used to coat a preform/mandrel produced using other AM approaches. This approach allows us to combine the advantages of both AM methods and is visually represented in FIG. 1, which depicts a method to produce high density reactive material fragmentation warheads with a dual AM approach.

Despite advancements in missiles technology, fragmentation warhead casings are often still produced using legacy materials, most commonly steel (density approximately 7.9 g/cm3). Application of new developments in manufacturing methods, materials processing, and advanced materials have the potential to significantly enhance the efficacy of fragmentation warheads on existing platforms. Advancements in AM enable the fabrication of geometries impracticable or impossible using traditional machining. New manufacturing methods allow for the use of novel materials with much higher density than steel and with secondary incendiary effects.

The use of higher density casing materials will allow for greater interceptor efficacy with the same form factor in a warhead compared to legacy warheads. With a fixed exterior geometry for a warhead and an optimized charge to metal ratio, switching to a higher density casing material will allow for an increase in both explosive mass and warhead casing mass.

Beyond optimizing the initial kinetic energy of the warhead, use of high-density materials offers additional advantages. High-density materials will travel further because drag will slow the fragments down less, increasing the kill envelope. Upon impact with a target, momentum of the fragment will determine the depth of penetration, which will be greater for a high-density material with the same speed as a lower density material. This will reduce the threshold and optimum fragment size, allowing a larger number of smaller fragments to be used, which will increase the probability of kill of a single or multiple targets.

Use of pyrophoric/reactive materials for warhead casings has the potential to further increase efficiency of warheads. Pyrophoric fragments have the potential to ignite explosives, damage electronics, and burn personnel. The nature of the target will determine the relative weighting placed on kinetic versus chemical energy when selecting warhead material.

The methods use traditional additive manufacturing (e.g., laser powder bed fusion, etch) to fabricate a sacrificial preform/mandrel onto which materials, such as but not limited to tantalum based materials are deposited using cold spray. Other sprayable materials with high density may be used. For example, as the art advances, other high density metals or metal alloys, such as but not limited to tungsten, may be used. The geometry imparted by the preform/mandrel can be used to change both the size and geometry of the resulting fragments. This will allow for implementation of novel geometries not achievable by traditional machining/notch methods.

Advantages of this approach include:

Greater efficacy with the same form factor using high density tantalum.

Multiple material solutions possible with cold spray, including, but not limited to tantalum-based intermetallic or thermite energetic materials. As described herein a cold-spray material includes a metal, or alloy thereof, (optionally) a ceramic, another, dissimilar metal or metal alloy, or a metal or metal alloy coated with a second dissimilar coating metal or coating metal alloy, or a ceramic coated with a metal or metal alloy, ceramic composite, metal-metal composite, or a combination thereof. Non-limited examples of suitable metals include Ta, W, Nb, Hf and their alloys, aerospace alloys Al 5000 series, 6000 series and 7000 series, Bismuth and lead and their alloys). Non-limiting examples of ceramics include oxides and non-oxides of the metals listed above and others such as aluminum oxide, silicon carbide, zirconium carbide, aluminum/silicon nitride. The other metal and the second dissimilar coating metal are independently selected from the list provided above.

Scalable cold spray process (deposition rates up to 10 kg/hr, build volume of 9 m×3 m×1.5 m) enables rapid prototyping and production of a wide range of warhead sizes. Size is generally determined by the equipment used, and is a non-limiting factor, except with respect to the equipment used.

Control of fragment shape using AM preform/mandrel to increase penetration.

Cold spray for high-rate deposition (up to 10 kg/hour) of high-density tantalum is used for the bulk of the warhead mass. In cold spray, metallic particles are accelerated to supersonic velocities with a heated, high-pressure gas. Feedstock powder, injected into the carrier gas stream is accelerated to a critical impact velocity in which upon deposition, plastically deforms and metallurgically bond in a manner similar to explosion welding. This process allows for the rapid buildup of bulk metallic articles. An advantage of cold spray compared to other AM processing methods is that it is an entirely solid-state, low thermal input process.

Because no melting occurs during the cold spray process, parts are free from cracks related to solidification and associated residual stresses. Cold sprayed tantalum exhibits density equivalent to that of wrought material (16.6 g/cm3) with porosity less than 0.1%. The cold sprayed tantalum tube shown in Error! Reference source not found. (bottom right) weighs 1 pound and was deposited with cold spray in 3 minutes. While tungsten has a higher density than tantalum (19.1 g/cm3), the low ductility of tungsten makes it difficult to deposit substantial amounts of high-quality material with the current state of the art in cold spray.

Cold spray is a versatile solid-state AM process that can be readily scaled to accommodate a wide range of warhead weights and geometries. The low heat input of the cold spray process does not require an inert atmosphere for processing, so scaling is much easier than processes such as powder bed fusion.

In addition to the high density of cold sprayed tantalum (16.6 g/cm3), tantalum is pyrophoric and can be used as a thermite constituent. Structural metal-metal oxide composites can be fabricated using cold spray to self-provide the oxygen source for combustion and have been reported in the academic literature. (A. Bacciochini et. al. Surface & Coatings Technology 226 (2013) 60-67.). In some cases, a metal-metal matrix can be utilized, for example aluminum and iron powder can be utilized. Use of a metal-metal oxide casing material ensures complete combustion of the metal and allows for pyrophoricity even in low-oxygen environments, such as the exo-atmosphere. These metal-metal oxide reactive composites will have a lower density than pure metals, and there will be a tradeoff between kinetic and thermal energy which must be taken into consideration. The heat of reaction and reactant density of several thermite reactions of interest are listed in Table 1. (Fischer, S. H. and Grubelich M. C. A Survey of Combustible Metals, Thermites, and Intermetallics for Pyrotechnic Applications. 32nd AIAA/ASME/SAE/ASEE Joint Propulsion Conference, 1996.)

TABLE 1
Density and heat of reaction for the
combustion of various thermites².

| | Reactant Density | Heat of Reaction | Heat of Reaction |
|---|---|---|---|
| Reactants | (g/cm³) | (cal/g) | (cal/cm³) |
| 4Al + 3WO₂ | 8.09 | 501 | 4047 |
| Ti + 2CuO | 5.83 | 731 | 4259 |
| Zr + 2CuO | 6.40 | 753 | 4818 |
| 4Ta + 5WO₂ | 13.52 | 145 | 1952 |
| 2Ta + 5CuO | 9.05 | 390 | 3532 |

Metal-metal composites also can react exothermically in the absence of oxygen; however, the heat of reaction is typically much lower than that of metal-metal oxide reactions. However, these metal/metal composites will generally have higher densities than metal/metal-oxide composites.

While cold spray is capable of deposition of high-quality materials at a high rate, the process does have limitations. Cold spray is a line-of-sight technique and is not capable of directly producing intricate geometries achievable with more traditional AM processes such as laser powder bed fusion. However, the use of a sacrificial preform/mandrel or preform/mandrel allows the geometry of the preform/mandrel to be imprinted upon the interior of the cold sprayed deposition. By using a preform/mandrel produced using a traditional AM method such as Powder Bed Fusion or Directed Energy Deposition, an optimized fragment size distribution and shape can be produced. While these methods have lower material build rates than cold spray, the preform/mandrel will have a comparatively smaller contribution to the mass of the warhead and thus not require excessive build times. The preform/mandrel can be removed following deposition using chemical means.

In addition to metal AM methods, it is possible to use lower-cost AM with polymers to produce highly complex geometries which can then be used as a pattern for a casting technique such as investment casting.

Thermite reactions often require a high temperature of ignition that can be difficult to achieve. For example, a strip of pure magnesium metal is often required to ignite the aluminum/iron oxide reaction. If higher temperatures are required during fragmentation to ignite pyrophoric fragments, this could be achieved by cold spray coating the preform/mandrel with a “fuse layer” which is more easily ignited such as zirconium.

### EMBODIMENTS

A cold spray material [for spraying] comprising a metal, or alloy thereof and (optionally) a ceramic (i.e., metal oxide, metal non-oxide), another, dissimilar metal or metal alloy, or a metal or metal alloy coated with a second dissimilar metal or metal alloy, or a ceramic coated with a metal or metal alloy, or a combination thereof.

In some embodiments, there may be two or more of any of the ceramic (i.e., metal oxide, metal non-oxide), another, dissimilar metal or metal alloy, or metal or metal alloy coated with a second dissimilar metal or metal alloy, or a ceramic coated with a metal or metal alloy, or a combination thereof.

Some embodiments include a process for making a fragmentation casing, said process comprising spraying a cold spray material, as described above on a preform/mandrel, wherein said preform/mandrel comprises one or more of a geometry, shape, texture, projection, aperture, depression, or other feature for imparting a plurality of fragmentation sites (e.g., stress concentrators) on the fragmentation casing.

A fragmentation casing for a bomb or warhead comprising a spray-coated casing material comprising a metal, or alloy thereof and (optionally) a ceramic (i.e., metal oxide, metal non-oxide), another, dissimilar metal or metal alloy, or a metal or metal alloy coated with a second dissimilar metal or metal alloy, or a ceramic coated with a metal or metal alloy, or a combination thereof, further comprising an imprinted structure (e.g., stress concentrators) for directing fragmentation.

In some embodiments, there may be two or more of any of the ceramic (i.e., metal oxide, metal non-oxide), another, dissimilar metal or metal alloy, or metal or metal alloy coated with a second dissimilar metal or metal alloy, or a ceramic coated with a metal or metal alloy, or a combination thereof.

A fragmentation casing for a bomb or warhead made by the spray coating process described herein.

Embodiment 1: A process in which cold spray material is used to produce a casing material on a preform/mandrel for a fragmentation warhead or bomb.

Embodiment 2: The cold spray material in embodiment 1 comprises a metal. The cold spray material comprises a ductile metal, and may also include oxides, non-oxides, or pyrophoric or non-ductile metals. Any suitable metal may be used. In some embodiments, the metal is tantalum, tungsten, magnesium, aluminum, titanium, copper, alloys, oxides, thereof.

Embodiment 3: The cold spray material in embodiment 2 is either a pure metal or an alloy

Embodiment 4: The cold spray material in embodiment 3 is pure tantalum or an alloy of tantalum

Embodiment 4: The cold spray material in embodiment 1 comprises a metal, alloy or oxide thereof and a ceramic.

The casing material that results from the cold spray material of embodiment 4 comprises a metal-ceramic composite.

Embodiment 5: The cold spray material in embodiment 4 is a metal-metal oxide composite.

Embodiment 6: The material in embodiment 5 is a Tantalum or alloy thereof and Tungsten Oxide Composite

Embodiment 7: The casing material produced in embodiment 1 is a metal-metal composite.

Embodiment 8: The casing material in embodiment 7 is a metal-metal composite consisting of a metal combination which release energy upon reaction.

Embodiment 9: The casing material in embodiment 7 is produced by spraying a mixture of ductile metal powder with a brittle metal powder.

Embodiment 9a: The casing material of embodiment 7, wherein the mixture is a mechanical mixture with substantially no chemical interaction before spraying.

Embodiment 10: The casing material in embodiment 9 is a mixture of tantalum or an alloy thereof and tungsten or an alloy thereof.

Embodiment 11: The casing material in embodiment 7 is produced by using brittle metals which are coated with a thin ductile metal prior to spraying. Ductile metal coating non-ductile metal (e.g., copper coating tungsten).

Embodiment 12: The material in embodiment 11 is pure tungsten coated with pure copper.

Embodiment 13: The warhead casing material in Embodiment 1 is built up of dissimilar layers of materials.

Embodiment 14: A dissimilar layer in embodiment 13 includes one more layers of metal with a low ignition temperature

Embodiment 15: The material in embodiment 14 is zirconium or an alloy thereof, magnesium or an alloy thereof, aluminum or an alloy thereof, or titanium or an alloy thereof.

Embodiment 16: A dissimilar layer in embodiment 13 includes one or more layers of a metal-metal oxide composite in which the metal constituent has a low ignition temperature.

Embodiment 17: The metal constituent in embodiment 16 is zirconium or an alloy thereof, magnesium or an alloy thereof, aluminum or an alloy thereof, or titanium or an alloy thereof.

Embodiment 18: A dissimilar layer in embodiment 13 includes a layer on the outer surface of the warhead casing.

Embodiment 19: A surface layer in embodiment 18 includes a layer for corrosion protection.

Embodiment 20: A surface layer in embodiment 18 provides thermal protection of the warhead.

Embodiment 21: A surface layer in embodiment 18 with a higher hardness that the rest of the casing material

Embodiment 22: The cold sprayed casing consists of a combination of materials listed in embodiments 2-12 and/or embodiments 14-21.

Embodiment 23: The preform/mandrel in embodiment 1 is designed such that the form factor of the warhead is optimized.

Embodiment 24: The preform/mandrel in embodiment 1 incorporates features into the casing material to control the fragmentation distribution.

Embodiment 25: The preform/mandrel in embodiment 1 is produced using metal casting.

Embodiment 26: The pattern for the casting in embodiment 25 is produced using additive manufacturing.

Embodiment 27: The pattern for casting in embodiment 26 is produced using fused deposition modeling.

Embodiment 28: The pattern in embodiment 27 is used for investment casting.

Embodiment 29: The preform/mandrel in embodiment 1 is produced using additive manufacturing.

Embodiment 30: The preform/mandrel in embodiment 29 is produced using a powder bed fusion method.

Embodiment 31: The preform/mandrel in embodiment 29 is produced using a directed energy deposition method.

Embodiment 32: The preform/mandrel in embodiment 29 is produced using wire-arc additive manufacturing.

Embodiment 33: The preform/mandrel in embodiment 29 is produced using additive friction stir welding.

Embodiment 34: The preform/mandrel in embodiment 29 is produced using binder-jet.

Embodiment 35: The preform/mandrel in embodiment 1 is not removed after cold spray.

Embodiment 36: The preform/mandrel in embodiment 1 is removed after cold spray

Embodiment 37: The preform/mandrel in embodiment 36 may be used more than once.

Embodiment 38: The preform/mandrel in embodiment 36 may only be once

Embodiment 39: The preform/mandrel in embodiment 38 is made of aluminum or an alloy thereof.

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. Therefore, about 50% means in the range of 45-55%.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also understood that this disclosure is not limited to particular compositions, methods, apparatus, and articles, as these may vary. It is also to be understood that the terminology used herein is for the purpose of describing particular embodiments only, and is not intended to be limiting.

What is claimed is:

1. A cold spray material comprising:
a metal, or alloy thereof, and
(optionally) a ceramic, another, dissimilar metal or metal alloy, or a metal or metal alloy coated with a second dissimilar metal or metal alloy, or a ceramic coated with a metal or metal alloy, ceramic composite, metal-metal composite, or a combination thereof.

2. The cold spray material of claim 1, wherein there are two or more of any of the ceramic, another, dissimilar metal or metal alloy, or metal or metal alloy coated with a second dissimilar metal or metal alloy, or a ceramic coated with a metal or metal alloy, or a combination thereof.

3. The cold spray material of claim 1, wherein the metal alloy comprises Tantalum or alloy thereof and the ceramic is a Tungsten Oxide Composite.

4. The cold spray material according to claim 1, wherein the material is a metal-metal composite.

5. The cold spray material according to claim 4 wherein the material is a metal-metal composite consisting of a metal combination which releases energy upon reaction.

6. The cold spray material in claim 5, wherein the material is produced by spraying a mixture of ductile metal powder with a brittle metal powder.

7. The cold spray material of 6, wherein the mixture is a mechanical mixture with substantially no chemical interaction before spraying.

8. The cold spray material of claim 7, wherein the mixture is a mixture of tantalum or an alloy thereof and tungsten or an alloy thereof.

9. The cold spray material of claim 7 produced by using brittle metals which are coated with a thin ductile metal prior to spraying.

10. The cold spray material of claim 9, wherein the brittle metal is tungsten and the thin ductile metal is copper.

11. A method for making a fragmentation casing, said process comprising
spraying a cold spray material on a preform/mandrel,
wherein said preform/mandrel comprises one or more of a geometry, shape, texture, projection, aperture, depression, or other feature for imparting a plurality of fragmentation sites on the fragmentation casing.

12. The method of claim 11, wherein the cold spray material is a cold spray material according to claim 1.

13. A fragmentation casing comprising:
a spray-coated casing material comprising
a metal, or alloy thereof
and (optionally) a ceramic, another, dissimilar metal or metal alloy, or a metal or metal alloy coated with a second dissimilar metal or metal alloy, or a ceramic coated with a metal or metal alloy, or a combination thereof;
further comprising an imprinted structure (e.g., stress concentrators) for directing fragmentation.

14. The fragmentation casing of claim 13, wherein the spray-coated casing material comprises two or more of any of the ceramic (i.e., metal oxide, metal non-oxide), another, dissimilar metal or metal alloy, or metal or metal alloy coated with a second dissimilar metal or metal alloy, or a ceramic coated with a metal or metal alloy, or a combination thereof.

15. The fragmentation casing according to claim 14, wherein the fragmentation casing is for a bomb or a warhead.

16. A fragmentation casing for a bomb or warhead made by the spray coating process described herein.

17. A preform/mandrel for forming a fragmentation casing, the preform/mandrel comprising:
features one or more of a geometry, shape, texture, projection, aperture, depression, or other feature for imparting a plurality of fragmentation sites on the fragmentation casing formed on the preform/mandrel.
